(19) United States
(12) Patent Application Publication
(10) Pub. No.: US 2015/0100268 A1
(43) Pub. Date: Apr. 9, 2015

(54) TRACKING SYSTEM APPARATUS

(71) Applicant: JIGABOT, LLC, Highland, UT (US)

(72) Inventors: Richard F. Stout, Highland, UT (US); Kyle K. Johnson, Eagle Mountain, UT (US); Eric Christensen, Draper, UT (US); David Long, Provo, UT (US); Vikas Asthana, Provo, UT (US)

(21) Appl. No.: 14/504,634

(22) Filed: Oct. 2, 2014

Related U.S. Application Data
(60) Provisional application No. 61/961,052, filed on Oct. 3, 2013.

(51) Int. Cl. G01S 17/66; H04N 5/232

(52) U.S. Cl. CPC G01S 17/66; H04N 5/23222
USPC 702/150; 250/338.1

(57) ABSTRACT

A system for tracking a cinematography target comprises an emitter configured to attach to a target and to emit a tracking signal that is directionally identifiable by a tracker. The emitter comprising an output module configured to emit the tracking signal. The tracking signal comprises a non-continuous electromagnetic signal according to a specified pattern, which specified pattern is selectable from a collection of distinct patterns.

### CROSS-REFERENCE TO RELATED APPLICATIONS

This application claims priority to U.S. Provisional Application Ser. No. 61/961,052 filed on Oct. 3, 2013, entitled “TRACKING APPARATUS,” which is incorporated by reference herein in its entirety. Additionally, this application incorporates by reference herein in its entirety U.S. patent application Ser. No. 14/045,445 filed on Oct. 3, 2013, which is entitled “COMPACT, RUGGED INTELLIGENT TRACKING APPARATUS AND METHOD.”

### BACKGROUND OF THE INVENTION

1. Technical Field

This invention relates to an automated position tracking system, and more particularly to novel systems and methods for automated position tracking in the fields of consumer or professional film & video production.

2. Background and Relevant Art

One reason that video and film production is difficult or expensive, is because it requires skilled labor: people who can operate cameras, lights, microphones, or similar devices with skill. Cameras, lights, microphones, and other equipment will, at various times, be hand held, or otherwise operated by trained individuals (for best effect), while actors, athletes, or other subjects are being filmed, lit, and recorded.

Recently, with the market arrival of low cost, high quality digital recorders, many non-professional and professional consumers have increasingly used recorders to document a variety of different events. For example, many consumers create films of themselves or others performing extreme sports, such as rock climbing, skydiving, motor cross, mountain biking, etc. Similarly, consumers are able to create High Definition quality films of family events, such as reunions, sporting events, graduations, etc. Additionally, digital video recorders have also become more prevalent in professional and industrial settings. For example, law enforcement departments have incorporated video recorders into police cruisers.

While recent advances in film and video creation and production have allowed consumers and professionals to easily create high quality videos of various events, it can still be difficult for consumers and professionals to acquire the quality and perspective that they may desire in their footage. For example, an individual may desire to record him- or herself snowboarding down a particular slope. One will understand the difficulty the individual would have in simultaneously filming themselves from a third person perspective, such as when they are skiing past a camera that is being swiveled on a tripod by an operator to keep them “in frame.” Similarly, a police officer may desire to record their interactions with the public, but a dash-mounted recorder only provides a limited and static field of view.

Accordingly, there is a need for systems, methods, and apparatus that can gather video footage of desired events and individuals without requiring direct and continual user interaction with the recording device.

### BRIEF SUMMARY OF THE INVENTION

Implementations of the present invention comprise systems, methods, and apparatus configured to track cinematography targets. In particular, implementations of the present invention comprise emitters that can be placed on targets and trackers that can automatically position a cinematography device (e.g., camera, light, microphone, etc.) to track the emitter.

A system for tracking a cinematography target comprises an emitter configured to attach to a target and to emit a tracking signal that is directionally identifiable by a tracker. The emitter comprising an output module configured to emit the tracking signal. The tracking signal comprises a non-continuous electromagnetic signal according to a specified pattern, which specified pattern is selectable from a collection of distinct patterns.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram of a computer system in a network connected to an internetwork, such as the internet for executing software, storing and generating data, and communicating in accordance with the invention;

FIG. 2A is a block diagram of a tracking system in accordance with the invention, including devices, subsystems, and software articles of manufacture effective to implement a system in accordance with the invention;

FIG. 2B is a block diagram of a preferred emitter device apparatus in accordance with the invention, including device components and software residing in memory effective to implement a system in accordance with the invention;

FIG. 2C is a block diagram of a emitter I/O subsystem apparatus in accordance with the invention, including device components and software residing in memory effective to implement a system in accordance with the invention;

FIG. 2D is a block diagram of a sensory subsystem apparatus in accordance with the invention, including device components and subsystems and software residing in memory effective to implement a system in accordance with the invention;

FIG. 2E is a block diagram of a preferred control subsystem apparatus in accordance with the invention, including device components and subsystems and software residing in memory effective to implement a system in accordance with the invention;

FIG. 2F is a block diagram of a positioning subsystem apparatus in accordance with the invention, including device components and subsystems and software residing in memory effective to implement a system in accordance with the invention;

FIG. 3A is a block diagram of a method or process in accordance with the invention, effective to implement a system in accordance with the invention;

FIG. 4A shows a formula enabling a means of smoothing and positioning the tracking device on a swivel axis, effective to implement a system in accordance with the invention;

FIG. 4B shows a formula enabling a means of smoothing and positioning the tracking device on a tilt axis, effective to implement a system in accordance with the invention;

FIG. 5A is a block diagram of a user configuration and scripting system in accordance with the invention, including devices, subsystems, and software articles of manufacture effective to implement a system in accordance with the invention;

FIG. 6 is an illustration of a mounted device (a camera), along with its attachment adapter, mounted above a tracking device, effective to implement a system in accordance with the invention;

FIG. 7A is a stylized illustration of some components constituting one embodiment of a tracking device, including those to make it compact, sturdy and water-proof, effective to implement a system in accordance with the invention;

FIG. 7B is another stylized illustration of a subset of components from a one embodiment of a tracking device, including those to make it compact, sturdy and water-proof, effective to implement a system in accordance with the invention; and

FIG. 7C is another stylized illustration of a subset of components of one embodiment of a tracking device, including those to make it compact, sturdy and water-proof, effective to implement a system in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention. The illustrated embodiments of the invention will be best understood by reference to the drawings, wherein like parts are designed by like numerals throughout.

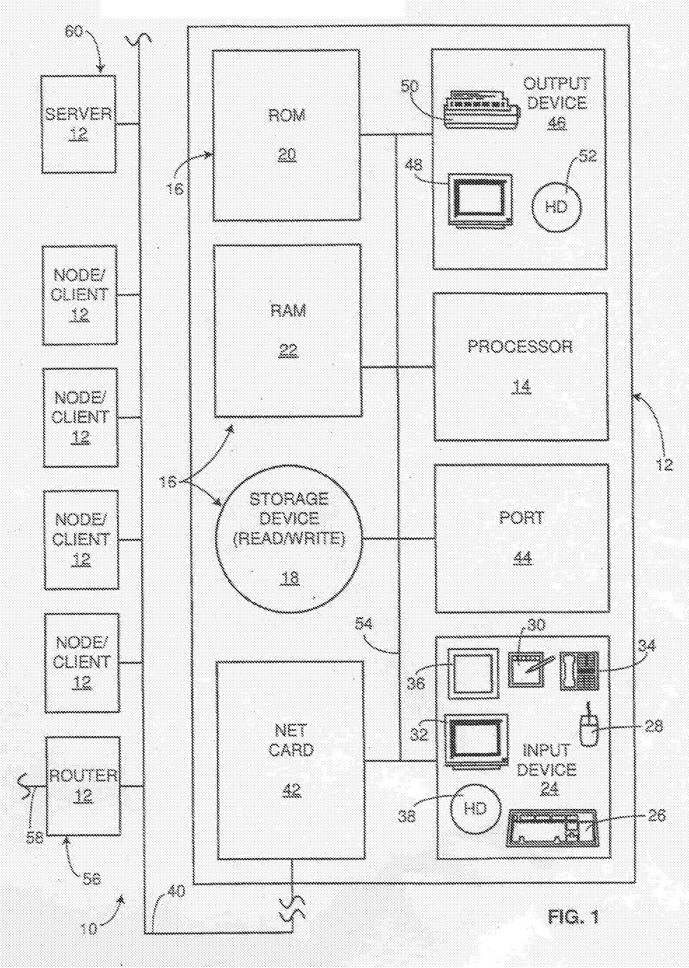

FIG. 1 is an illustration of an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30 or touch-screen pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, and output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (ie., network 40 and neighboring network 58), or may be separated by multiple routers 56 and multiple networks as individual nodes 2 on an internetwork. The individual nodes 12 may have various communication capabilities. In certain embodiments, a minimum logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

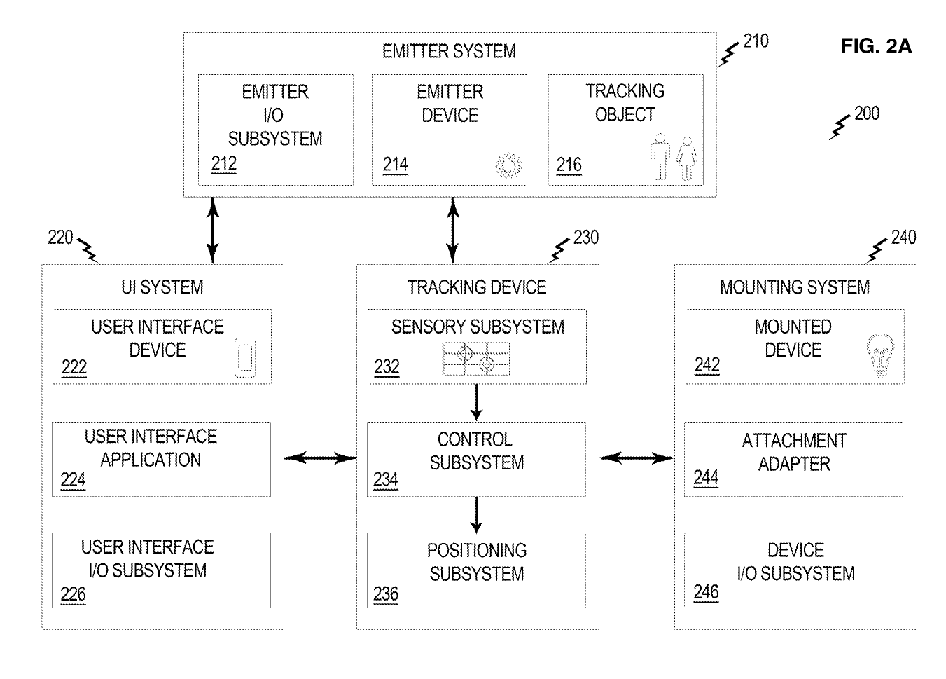

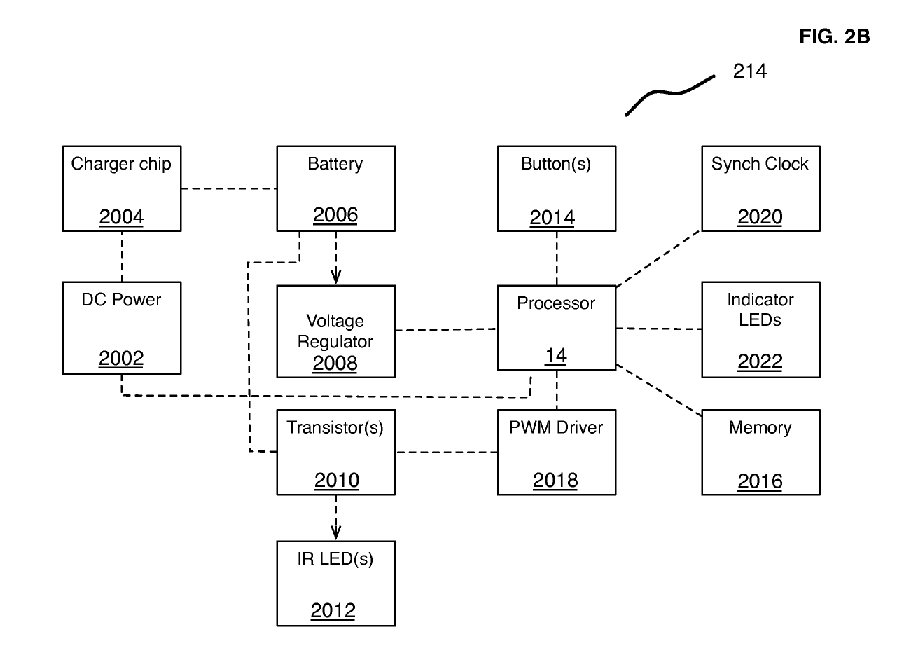

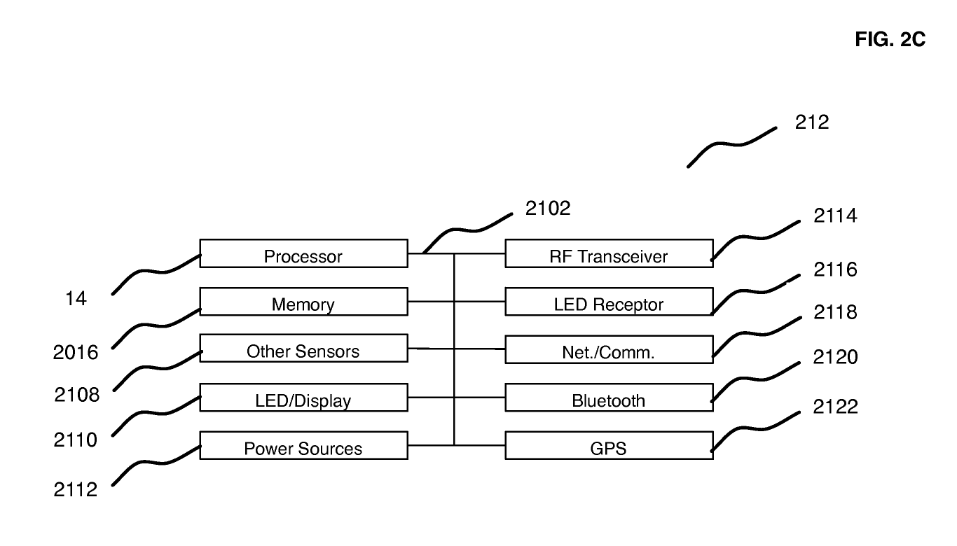

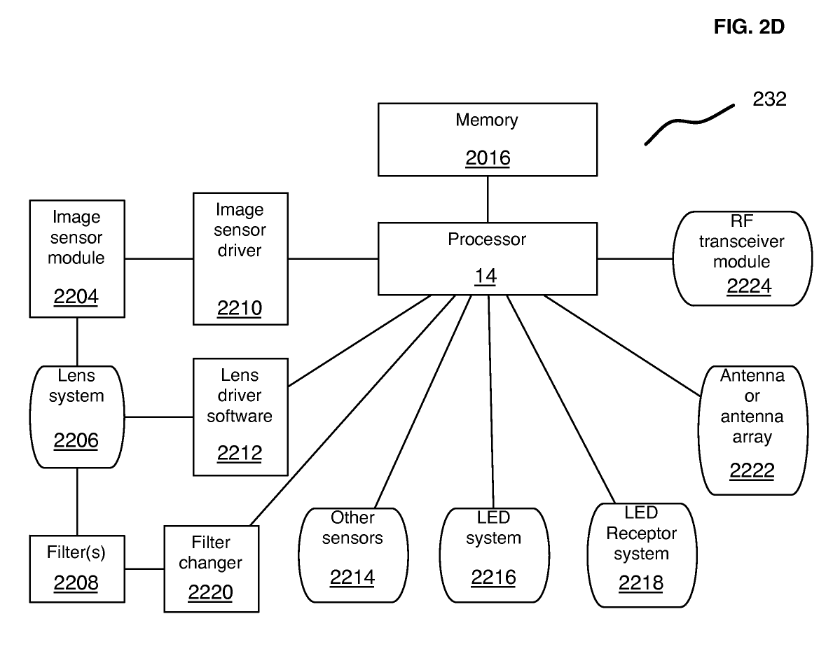

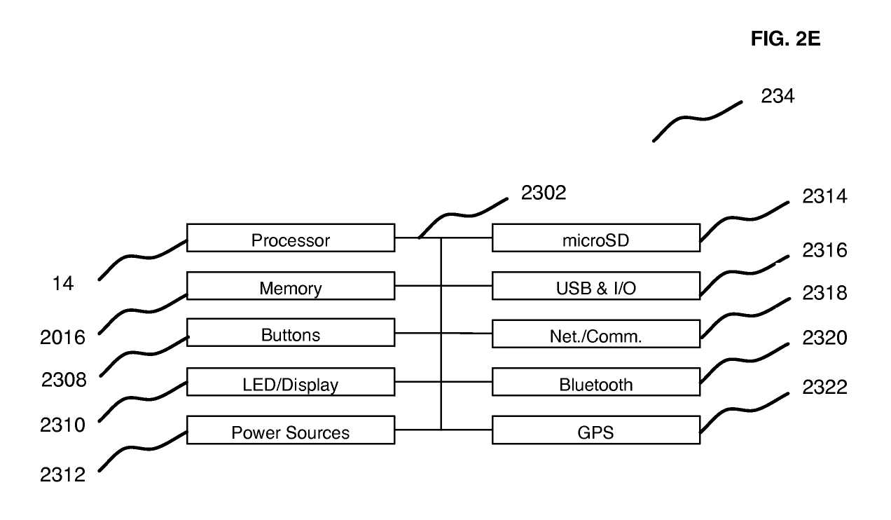

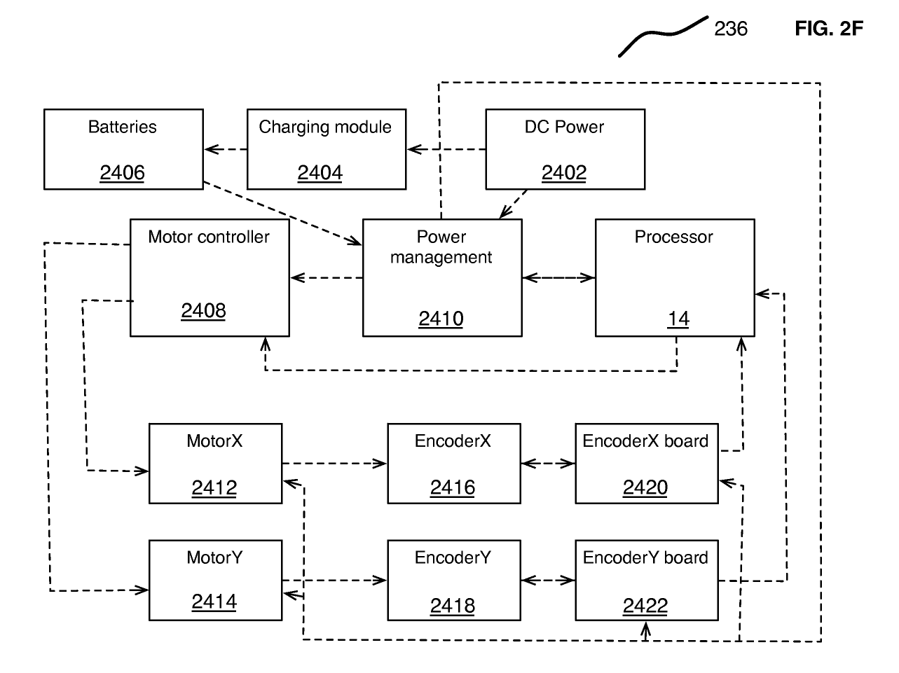

FIG. 2A is an illustration of a tracking system or apparatus 200 for implementing the present invention, may include one or more emitter systems 210 (in whole or part), which are followed or tracked by one or more tracking devices 230, upon which may be mounted one or more mounting systems 240 (typically, in a preferred embodiment, a single mounting system 240 would be associated with a single tracking system 230), all of which systems may be configured or automated and otherwise controlled by one or more user interface (UI) systems 220.

In its simplest form, the tracking system 200 is comprised of a single emitter system 210, which would be tracked by a single tracking device 230, upon which is mounted a single mounting system 240, and the tracking device 230 would be configured or otherwise controlled by a UI system 220.

The emitter system 210 may be comprised of an emitter I/O subsystem 212 and/or one or more emitter devices 214 attached to or placed on a person (or persons) or other object (or objects) 216.

In a preferred embodiment, the emitter I/O subsystem 212 is connected (at least at times) with the emitter device 214, and may include a computer system 12, or parts thereof (or similar parts thereof including RAM 22, a processor 14 chip, a wireless net card 42, and batteries or other power supplies), in order to enable the emitter device 214 to be configured and otherwise controlled directly or from the UI system 220, and to pulse according to a unique and pre-configured or use-selectable/configurable pulse rate or modulation mode.

Via an emitter I/O subsystem 212, one or more emitter devices 214 may be turned on or off, may begin or stop emitting or signaling, may be modulated or pulsed or otherwise controlled in such a way as to be uniquely distinguishably by the tracking device 230.

The emitter I/O subsystem 212 may also receive signals from or send signals to an emitter device 214, or the UI system 220, or the tracking device 230, and the mounting system 240 directly or via one or more tracking devices 230 or UI systems 220.

The emitter device 214, in a preferred embodiment, is a type of infrared light (such an LED), but may be a supersonic audio emitter, a heat emitter, a radio signal transmitter (including Wi-Fi and bluetooth), or some other similar emitter device or system or subsystem, including a reflective surface from which a color of shape can be discerned by the sensory subsystem 232.

One or more emitter devices 214 modulate, pulse, or otherwise control emitted signals or light (visible or non-visible, such as infrared), or sounds, or thermal radiation, or radio transmissions, or other kinds of waves or packets or bundles or emissions, in order to be discernible to a tracking device 230. The tracking device 230 may communicate with the emitter device 214 via the UI system 220, or the emitter I/O subsystem 212 or both, in order to enhance, clarify or modify such emissions and communications from one or more emitter devices 214.

In a preferred embodiment, the emitter devices 214, are embedded within clothing (such as sport team jerseys, ski jackets, production wardrobe, arm bands, head bands, etc.) equipment (such as football helmets, cleats, hang gliders, surfboards, etc.), props (glasses, pens, phones, etc.), and the like, in order to “hide” the emitter device 214 from being obviously visible to spectators. Micro batteries and other power sources may be used to power the emitter devices 214.

Small emitter devices 214 can be hidden beneath a logo, or integrated with a logo, so as to be prominently visible. Likewise, fashion accessories, such as hats, shirts, shorts, jackets, vests, helmets, watches, glasses, may well be fitted with emitter devices 214, such that the device may be visible and obvious, and acceptably so, for its “status symbol” value.

Tracking objects 216, including people, animals, moving objects such as cars or balls, may all be fitted with emitter devices 214 (whether embedding in clothing being worn, props being carried, equipment being used, or fashion accessories being worn) effectively signaling or emitting their presence, as they move about.

The typical ways in which a tracking object 216 does move about may be known to the UI system 220, via user configuration or input and embedded system algorithms or software. Thus, as the tracking object 216 moves about, the tracking device 230, which communicates with and may be configured, or programmed by the UI system 220, can tilt or swivel, or move in 3D space, in order to follow, and track the tracking object 216, according to a user's preferences or predefined activity configurations or programmed scripts. And as the tracking device 230 thus tracks the tracking object 216, the mounted system 240 and device 242 (be it a camera, light, or microphone), can also follow the tracking object 216 in synchronous motion as well as in ways and patterns “predicted” in part by what that the user configures or programs.

The UI system 220 includes a user interface device 222 (such as a smartphone or other computer 12 device), a user interface application (app) 224, and a user interface I/O subsystem 226 which enables the UI system to communicate to and from the other systems 200 and other devices 210, 220, 230, and 240 within the tracking system 200, and other computers 12.

In one preferred embodiment, the user interface device 222 runs the user interface app 224, and communicates through the user interface I/O subsystem 226 which is typically embedded within, and is a part of, the user interface device 222. The user interface device 222 runs the user interface app 224, allowing users to easily configure one or more emitter devices 214, tracking devices 230, mounted devices 242, and to automate activities within the tracking system 200 via scripts, illustrated later. The user interface application 224 may be programmed to perform other features of sensory input and analysis, beneficial to some other system 200, as well as to receiving user tactile input and communicating with the tracking device 230 or the mounting system 240 of the immediate system 200.

In at least one embodiment, the user interface app 224 may additionally enable other activities as well. For example, the user interface app 224 can be used to specify from a list the kind of activity that a tracking object 216 is participating in (jumping on a trampoline, walking in circles, skiing down a mountain, etc.). Additionally, in at least one embodiment, the list that may be partially completed, and can be added to and changed by a user.

The user interface app 224 may additionally allow users to diagram the activities expected by the tracking object 216, define an X and Y grid offset for the tracking of the emitter device 214 by the tracking device 230, specify an offset by which the user wants the action to be “led” or “followed,” etc. (if tracking other than just by centering of the emitter device 214 by the tracking device 230.) For example, the tracking device 230 may generally follow the emitter device 214 by bias its centering of the tracking object 216 in some manner pleasing to the user. The user interface app 224 may additionally enable interpretation, change, or control of the identification signal (or emitted, modulated signal) or the emitter device 214. It may also manage and enable the user interface device 222, and the user interface I/O subsystem 226, to accomplish tasks and processes and methods identified later as useful for this other somehow interconnected systems 200.

The user interface app 224 may additionally enable updating of one or more computer 12 devices of UI system 222, tracking device 230, mounting system 240, or emitter system 210, or other computers 12 connected to the tracking system 200, and to provide for execution unique and novel formulas or algorithms or scripts or configuration data, enabling improved functioning of the tracking device 230 or other systems within the tracking system 200.

The tracking device 230 may include one or more sensory subsystems 232, control subsystems 234, and positioning subsystems 236. The sensory subsystem 232 may be comprised of one or more sensors or receivers including infrared, RF, ultrasonic, photographic, sonar, thermal, image sensors, gyroscopes, digital compasses, accelerometers, etc.

In a preferred embodiment, the sensory subsystem 232 includes an image sensor that reacts to infrared light that is emitted by one or more emitter devices 214. The sensory subsystem 232 may be designed specifically to identify more than one emitter device 214 simultaneously. The sensory subsystem 232 may be capable of identifying multiple emitter devices 214 that are of the same signal or modulation or pulse rate, or of different signals or modulations or pulse rates.

If multiple emitter devices 214 are of the same signal, modulation, or pulse rate, they may be perceived by the sensory subsystem 232 as a single light source (by means of a weighted average of each, or by some other means), although in fact they may combine to represent a single “point cloud” with multiple, similar signals, modulations, or pulse rates.

If multiple emitter devices 214 are of different signals, modulations, or pulse rates, they may be perceived by the sensory subsystem 232 as distinct from each other: creating in effect multiple light sources within the perception of the sensory subsystem 232. Each light source perceived by the sensory subsystem 232 may be converted to a X and Y position on a two-dimensional grid, as if a cartesian coordinate system, by the sensory subsystem 232 and/or control subsystem 234.

The two dimensional grid may be understood as an image sensor onto which light is focused by lenses, as in a camera system, of which the sensory subsystem 232 may be a kind. The image sensor may be a two-dimensional plane, which is divided by units of measurement X in its horizontal axis, and Y on its vertical axis, thus becoming a kind of measurement grid.

Several times per second (perhaps 24, 30, or 60 or some other common video frame rate), the location of each unique emitter device 214 (based upon a unique signal or modulation, or pulse rate, or perhaps some other identifiable marker), or of each “point cloud” represented by a group of similar emitter devices 214 (based upon a unique signal or modulation, or pulse rate, or perhaps some other identifiable marker), may be given an X and Y coordinate representation, which may be represented as two integer numbers.

In a simple embodiment, the tracking device 230 uses the X and Y coordinate data to calculate (via the control subsystem 234) a distance from a center X and Y position, in order to then position tilt- and swivel-motors via a positioning subsystem 236 to “center” the emitter device 214 within its two-dimensional grid. The net effect is that the tracking device 230 tilts and swivels until “facing” the emitter device 214, or emitter device 214 “point cloud.”

In a more sophisticated, novel and unique embodiment, several times per second the tracking device 230, identifies an X and Y coordinate for each emitter device 214, or “point cloud” (cloud) of emitter devices 214. These X and Y coordinates may be saved as a history of coordinates (perhaps appended to a data array unique to each emitter device 214 or emitter device 214 cloud) by the control subsystem 234 which may be a computer 12 or parts thereof including a processor 14 and memory (which might be embedded flash memory, or memory as from a removable SD card, or residing in an internet “cloud.”) Over time, these data arrays represent a history of travel of the emitter device 214 or cloud. These data arrays are then analyzed by a control subsystem 234, possibly based upon configuration data that may come from the UI system 220, in order to “fit” their data history into mathematical curves or vectors that approximate the array data history of travel, and also “predict” X and Y coordinates of future travel. In this manner (and in similar ways) the tracking device 230 may thus obtain and analyze data whereby it might “learn” how to better track the tracking object 216 and the emitter device 214 over time or in similar situations in the future.

Thus the control subsystem 234 may control a positioning subsystem 236, and its tilt and swivel motors, in a partly “predictive” manner, that “faces” the tracking device 230 at the emitter device 214 or cloud over time. (This may be particularly useful in cases where the emitter device 214 is partly or fully obscured for at least a period of time.) The net effect of a “learning” and “predictive” tracking capability may yield a more “responsive” and “smooth” tracking activity than would be the case with the simple embodiment or tracking/centering approach alone. The control system 234 may employ other unique and novel mechanisms to smooth the tilt and swivel motors of the positioning subsystem 236 as well, including using unique mathematical formulas and other data gathered via I/O subsystems 246, 226, 212 or those of other tracking systems 200. Triangulation of emitter devices 214, and related tracking device 230 control may thus be enabled.

The positioning subsystem 236 responds to controls from the control subsystem 234 to control servo motors or other motors, in order to drive rotation of the device on a tilt axis, rotation on a swivel axis, and perhaps rotation on a third axis as well.

The mounting system 240 can include a mounted device 242 (such as a light, camera, microphone, etc.), an attachment adapter 244 (which enables different devices to be adapted for mounting quickly and easily), and a device I/O subsystem 246 (which, in a preferred embodiment, enables communication and control of the mounted device 242 via a tracking device 230, UI system 220, or emitter I/O subsystem 212, or some combination of these, including other systems and subsystems of other tracking systems 200.) In at least one embodiment, the mounting system does not include the mounted device 242, but instead, the mounted device 242 can be external to the mounting system 240. Data from the mounted device 242 may also be provided to the tracking device 230 or the UI system 220 or the emitter system 210 in order that system 200 performance may be improved thereby in part.

The mounted device 242 may be affixed via the attachment adapter 244 to the tracking device 230, such that the mounted device 242 may be tilted or swiveled in parallel with the tracking device 230, thus always facing the same direction as the tracking device 230. Additionally, the mounted device 242 may be controlled via the device I/O subsystem 246 (and perhaps also via the UI system 220 or the tracking device 230), in order to operate the mounted device 242, simultaneous, perhaps, to the mounted device 242 being positioned by the tracking device 230.

FIG. 2B is a block diagram of a device or system 214 for an emitter. It is capable of the following: Pulsing IR LEDs 2012 according to a pulse ID mode generated by a processor 14, via a PWM driver 2018, or similar device, that may reside within the processor 14, which may originate from a user pressing a button or buttons 2014. By pressing the button 2014, the device 214 providing a means for users to toggle/select a particular pulse ID mode, which may be indicated to the user via indicator LEDs 2022.

The various pulse ID mode may comprise pre-determined designations, such as “Pattern Number 1,” “Pattern Number 2,” etc. In contrast, in at least one implementation, a user may be able to name the various patterns. In particular, the user may desire to name the patterns based upon the device that the emitter is associated with. For example, a pattern may be named “Quarterback,” while another may be named “Wide-Receiver.” Additionally, in at least one implementation, the emitter system 210 can communicate the names to one or more tracking devices 230. The communication can be through BLUETOOTH, WIFI, physical connection, or through a pulse of IR light or RF communication.

In at least one implementation, upon receiving the information, the tracking device 230 can provide a user with the option to track a particular named pattern. For example, the user may be filming a football game and wish to quickly switch between tracking the quarterback and the wide-receiver. Accordingly, implementations of the present invention, provide a user with the ability to easily select between named patterns at the tracking device 230.

The IR LEDs 2012 may be powered by batteries 2006 or DC power 2002, where current may pass thru transistors 2010 leading to the IR LEDs 2012. The processor may be powered either via DC power 2002, or batter 2006 where power may be regulated via a voltage regulator 2008 before reaching the processor 14.

The processor 14 may use a clock synchronization signal 2020 in order to time the pulsing/modulating signal of the IR LEDs 2012, in order to synchronize them or otherwise time their pulsing relative to other emitters 214. Thus clock synchronization 2020 and processor 14 functioning, can coordinate the timing and pulsing mode of IR LED 2012 emissions, and perhaps other functioning, of multiple emitters 214.

Accordingly, in at least one implementation, a large group of emitters can all be pulsing the same pattern, at the same frequency, and while time synced. Accordingly, in at least one implementation, the tracking device 230 can identify a large group of emitters all pulsing the same pattern. The tracking device can then track the entire group as if it were a single point, but averaging all of the relative locations of each emitter. In the case of a large number of different emitters all pulsing, having the patterns synced can significantly simplify signal processing at the tracking device 230.

The emitter device 214 is capable of storing in memory software code that can be run on a processor, and which programmatically enables the functioning of the device. The components of system 214 such as 2014, 2010, etc. are connected by lines illustrating a subset of bus or trace connections between potentially all of the components of 214. All of these components of 214 might be programmatically affected by the processor 14, via a user interface system 220, or an emitter I/O subsystem 212.

FIG. 2C is an illustration of a system 212 that is an emitter I/O device capable of various functions including the following: sending encoded signals via an RF transceiver 2114, which have been encoded or modulated via a processor 14 and software code in memory 2016, via a bus or traces or ports 2102 shown in partial representation herein.

The system 212 is also capable of receiving encoded signals via an RF transceiver 2114, which can be decoded and interpreted via a processor 14 and software code in memory 2016. Memory 2016 used in system 212 and elsewhere may include all or portions of ROM 20, RAM 22, and other storage device memory 18.

RF transceiver 2114 may be a subsystem, and include an antenna, which may be multi-directional, as well as other components needed encode and transmit a modulated signal, such as a PLL and VCO, bandpass filters, amplifiers, mixers, ADC units, demodulators and so on.

The system 212 is also capable of sending encoded signals via LEDs 2110, which may or may not be IR LEDs 2012, and which can be sensed and decoded and processed 14 by other systems 212 or tracking devices 230. Such might be useful for coordinating or sharing data, including positioning data for triangulation activities, or pulse/modulation data.

In at least one implementation, the system 212 can overlay a communication frequency on top of the pattern or tracking frequency. For example, a user may select a particular frequency and pattern for the emitter device 214 to emit, such that the tracking device 230 can track the emitter device 214. In at least one implementation, however, the emitter I/O system 212 can overlay a communication stream on top of the tracking pattern and frequency, such that the tracking device 230 and the emitter system 210 can engage in two way communication using the user selected signal pattern that the tracking device 230 is using to track the emitter device 214.

The system LED/Display 2110 may simply be used to inform a user of modes or data settings of the device 212 or device 214.

Sensing data is obtained from sensors 2108, and can be encoded and transmitted or sent by IR 2110 or 2012, or RF 2114, or other means such as ultrasonic sound. Sensor data 2108 includes but is not limited to the following sensor 2108 data: accelerometer data, gyroscope data, altimeter data, digital compass data, GPS data, ultrasonic sound data sourced from one or more different directions simultaneously.

Sensing data from sensors 2108 can be used by the tracker 230 to better track an emitter 214, even when an emitter 214 may not be visible. For example, the emitter 214 can communicate the sensor data to the tracker 230 while the emitter 214 is visible to the tracker 230. Using the received data, the tracker 230 can predict where the emitter's position. Sensing data from sensors 2108 may provide data about direction of travel, changes of direction, velocity of travel, changes in velocity, location data, altitude data, and so on—all of which might enable the tracking device 230 control subsystem 234 to better track the emitter 214 via the positioning subsystem 236 activities.

System 212 may both send encoded signals via a bluetooth protocol, and receive encoded signals via a bluetooth protocol via a bluetooth device 2120. Such may enable the UI system 220 to better communicate with the emitter system 210, or for the tracker 230 to better communicate to and from and with the emitter system 210 as a result. Similarly, other subsystems such as the device I/O subsystem 246, or other devices within or outside of system 200 might thus be able to communicate with the emitter system 210, and hence with the UI system 220 or the tracker 230 or mounting system 240.

System 212 may both send encoded signals via a wi-fi protocol, and receive encoded signals via a wi-fi protocol. And thus, like with the bluetooth device 2120, the Net./Comm. device 2118 might enable communications with other devices within and without the system 200.

System 212 may store in memory software code that can be run on a processor 14, and which programmatically enables the functioning of the device 212.

FIG. 2D is an illustration of a system 232 that is a sensory subsystem apparatus capable of enabling various features including the following: controlling via a processor 14 an image sensor's 2204 settings and receiving images into memory 2016 that were obtained from an image sensor 2204 for processing and analysis by a processor 14.

These two functions of controlling settings and receiving images may be enabled via an image sensor driver 2210, controlled by a processor 14, and used iteratively and together in order to optimize changes of the image sensor 2204 until the resulting image is ideal for use by the control subsystem 234.

System 232 includes a lens system 2206 capable of adjusting the field of view of the signal that reaches the image sensor 2204. In one embodiment, a lens driver software 2212 enables the lens system 2206 to be programmatically controlled and zoomed by a processor 14 and software in memory 2016. Additionally, in at least one implementation, a user can adjust to lens to determine how tightly constrained the field of view of the tracker should be.

System 232 includes filters that limit the frequency of the emitter signal reaching the image sensor. Useful filters may include narrow-pass filters 2208 or other band-pass filters 2208, or IR (block) filters 2208, useful when a tracking object's 216 associated distinguishing feature may enable image tracking by the sensory subsystem 232 and the control system 234 without the use of IR light. Useful filters may also include “dual-pass” filters 2208, allowing a range of visible light, and a range of IR light, but no other light or signal.

In a preferred embodiment, the frequency of emission of an IR LED 2012 within an emitter device 214 is matched with the “pass” frequency of a narrow bandpass filter 2208 within the tracker 230 or sensory subsystem 232 or 214, blocking noise or distracting light or signal from the image sensor 2204 while allowing to pass light or signal from the LED 2012. Thus improving the functioning of the system 232.

System 232 may include a programmatically controllable filter changer device 2220 that swaps or switches filters 2208 depending upon control from the processor 14 or from a user.

System 232 may include a programmatically controllable LED receptor 2218 capable of sensing LED signals that may be pulsed or modulated from emitter 214 or I/O system 212, and provide related data to processor 14 for interpretation and analysis. Such receptor 2218 data may also be stored in memory 2016 in order to be combined with other data, or analyzed at another time by the processor 14.

An LED system 2216 capable of emitting signals that can be pulsed or modulated with encoded data by a processor 14. Such emitting by 2216 may enable methods of communication with emitter device 214 or I/O subsystem 212.

RF transceiver module 2224 is capable of transmitting or receiving signals via an antenna or antenna array 2222 via its programatic connection to a processor 14. This can be useful to communicate with an emitter 214, or other tracker 230, or another device within system 200 or another system 200. However, it can be useful for much more than that:

RF transceiver module 2224 is capable of transmitting or receiving signals via an antenna or antenna array 2222 via its programatic connection to a processor 14. But this module 2224 may include a PLL and VCO and 4-way splitter (one for each of 4 receiving antennas), as well as four or more bandpass filters, amplifiers, mixers, ADC units, and demodulators, sufficient to sense an emitter 214 location relative to the tracker 230 location.

Other sensors 2214, may gather data for storage in memory 2016, and processing by a processor 14. Such other sensors 2214 data may include the following: accelerometer data, gyroscope data, altimeter data, digital compass data, GPS data, ultrasonic sound data sourced from one or more different directions simultaneously.

The processor 14 may store other software and data in memory 2016 in order to enable functioning of this system 232 within the tracking system 200.

FIG. 2E is an illustration of a system 234 for a block diagram of a preferred control subsystem apparatus capable of enabling various functions, including the following: processing data via the processor 14. Holding data and software code in memory 2016. Executing via the processor 14 software code in memory 2016 in order to control and receive data from other modules of system 234, via a bus or port or trace 2302.

This includes the processor 14 and other components of 234 receiving power from power sources 2312, and for the processor 14 to affect and control power features of power sources as by a power processing unit.

System 234 may include a button or buttons 2308 for configuring the control modes or other functioning of the tracking device 230, or other devices or functions of system 200.

System 234 may include a microSD memory 2314 device, or similar storage device, useful for storing software and data for processing by the processor 14.

System 234 may include a USB & other I/O module 2316 enabling on-the-go USB capabilities of controlling and being controlled by other devices, and may enable configuration of the tracker 230 and providing of firmware upgrades for the tracker 230 and other devices of system 200. An external wi-fi or bluetooth or similar device may be attached via the USB & I/O module 2316 enabling communications between the tracking device 230 and other devices, including the UI system 220, the emitter system 210, and the mounting system 240.

An internal wi-fi 2318 or other communication device 2318, or a bluetooth device 2320 may also enable communication between the tracking device 230 and other devices, including the UI system 220, the emitter system 210, and the mounting system 240. In such embodiments, an external wi-fi or bluetooth or similar device attached to 2316 may or may not be necessary.

Either 2316 or 2318 may enable a user to interact with the control system 234 and to program it or otherwise work with it as one might with a computer system 10. Thus “power users” may be enabled to develop applications for the device independent of what the tracking device 230 providers would themselves provide.

System 234 may also include a GPS system 2322, enabling the location of the control system 34 or tracker 230 to be processed by the processor 14 in a useful manner. One such useful manner may be to enable the defining of grids of space within which other tracking devices 230 are located, and within which other emitter systems 210 are located. As such, in at least one implementation, the system 234 comprises a grid that provides relative positions of one or more emitters and other trackers. Additionally, in at least one implementation, the grid is viewable by a user. In at least one implementation, the user can use the grid to draw a predicted path of a particular emitter. The predicted path can then be used by the tracking device to track the particular emitter. Triangulation methods might be used, partly from GPS 2322 data, and from other data generated by the sensory subsystem 232 or the UI system 220 or the emitter system 210 or the mounting system 240 to provide useful analysis by the processor 14 for advanced tracking activities within systems 200.

FIG. 2F is an illustration of a preferred system 236 for a positioning subsystem apparatus capable of various functions including the following: battery and/or DC power operation and/or charging via a possible charging module 2404, a possible DC power module 2402, and possible batteries 2406.

A positioning subsystem 236 may also include motors 2412 and 2414 controlled by a motor controller 2408. One motor 2412 is for the x-axis or swivel motion of the tracker 230, and the other motor 2414 is for y-axis or tilt motion of the tracker 230. The motor controller may be controlled by a processor 14.

The motors 2412 and 2414 may include encoders 2416 and 2418 respectively, which are attached to and thereby rotate with the movement of the motors, and reflect a signal from an encoder board 2420 and 2422, back to the same encoder board 2420 or 2422.

The encoder boards 2420 and 2422 or system 236 emit a signal which might be an IR LED emission, which is then reflected back in a particular manner by the physical design of the encoder 2416 or 2418, so as to produce signals discernible by the encoders 2420 and 2422 and instructive of rotation count (or partial rotations) and speed of rotations.

The encoder board 2416 or 2418 may send its sensed data to a processor 14 for further analysis and use within system 2302 and/or storage in memory 2016 or otherwise sent via the bus 2302 to other components of 234.

By a unique method of iteratively controlling the motor controller 2408, and analyzing data from the encoder boards 2420 and 2422, the processor 14 can better control the motion of motors 2412 and 2414 in order to achieve a smooth motion of the tracker 230 and the mounting system 240. This system 236 also provides benefits of enabling the tracker 230 to be configured or programmed by the UI system to “act out” scripts, including the repeating of previously executed motor 2412 and 2414 activities, which were sensed by 2420 and 2422 and saved into memory 2016 or 2314 by the processor 14.

Power management 2410 may be capable of providing power functions to subsystems of 236 or 234 and may including these: powering up; powering down; sleeping; awaking from a sleep mode; providing proper voltages, currents, and resistance's to enable function of the device; and providing these things in proper, programmable sequences relative to the components found in system 236, 234, or other systems within 200. Thus power as well as data I/O may travel between subsystems 230, 240, 220, and even 210 for example in a situation where the emitter system 210 is tethered for charging or other purposes to tracker 230.

System 236 includes the storing in memory 2016 or 2314 of data and software code that can be execute and analyzed on a processor 14, in order to programmatically enable the functioning of the device or system 236 as well as other related devices or systems or processes within 200.

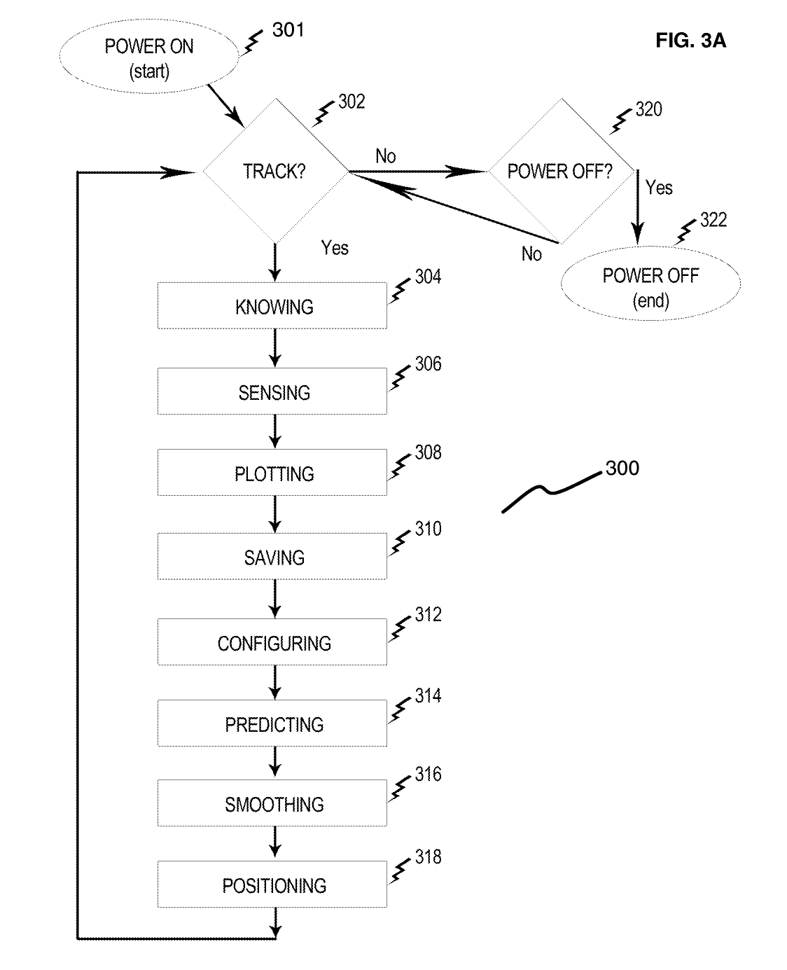

FIG. 3A is an illustration of a system, method, or process 300 for implementing the present invention, and more generally for enabling the control system 234 to properly affect the positioning subsystem 236 via data gathered from the sensory subsystem 232, and the UI system 220, and perhaps the mounting system 240 as well as from other tracking systems 200. In a preferred embodiment, process 300 may be contained within software within memory, or in whole or in part within an FPGA device designed for this purpose.

Thus system 300 may be embodied in software or hardware, and may include one or more buttons or switches, and computers 12 (or parts thereof), and logic boards, and software programs. In a preferred embodiment, system 300 resides within the control system 234, but it might reside in whole or in part in the UI device 222, the mounted device 242, or the emitter device 214, or in other devices or system of other somehow interconnected systems 200.

Labeled items 301, 302, 304, etc. may be thought of as tasks that are executed via user input, or by system function, or by partly via programmable scripts, in order to achieve the overall process or logic flow required by the present invention.

Portions of method 300 may be represented by one or more devices. For example, a button or similar switch or device 301 is used to power on the tracking device 230, and enables the process defined in method or system 300. If button 301 has been depressed properly, the tracking device 230 is in a state of “being powered on.” After the power is switched on, a user may determine if the process is actually to begin, by (optionally) answering the question of whether or not he/she is ready to track (302). Alternatively, question 302 (as well as other questions of system or method 300) may be answered by the system or by a user configuration setting, or pre-programmed script.

In a preferred embodiment, a button is used to power on 301, and which also commences “automatically configuring” the tracking device 230 to the pulse modulation mode of the present or closest emitter 214. If button 301 is immediately pressed again, it the emitter modulation mode may be incremented to a next appropriate mode, thereby enabling the tracking system 230 to track only emitters 214 configured to this next modulation mode. In any case, after button 301 is pressed, the tracking device may shortly thereafter begin tracking automatically an emitter with the selected or configured modulation mode. There may also be visual LED prompts that aid the user in these activities, as well as to help the user readily identify the state that the tracking device 230 is in relative to process 300.

By answering Yes to the tracking question 302, and if it hasn't already thus changed, the tracking device 230 will be switched into a state of “tracking” and will begin (if it hasn't already done so) the task of learning or knowing 304 what kind of emitter device 214, or emitter device 214 cloud (of similar modulation, pulse rates, or signals) it is to track. Not withstanding the tracking device 230 may sense multiple different emitter devices 214 or clouds at any given time, it is generally going to be configured to follow a single emitter device 214 or cloud at a given time.

The task of knowing 304 is the system task of checking a variable, within a system (perhaps a software or hardware or similar system) embedded in the control system 234 (which may be a computer 10, or parts thereof), which stores the name or identifying ID of the target emitter device 214 or cloud. Thus knowing 304 enables the tracking device 230 to begin searching for or sensing 306, the unique modulation/signaling/pulsing ID associated with the proper emitter device 214 or cloud. This act of “knowing” may be initiated by pressing the button 301 at or near the act of powering on the device 230, as discussed previously, or it may be accomplished by a user pressing this same button 301—or via some other method using the UI system 220, or some other method—during a tracking activity, as might be the case if the user decides to switch the modulation modes and thus to track a different emitter 214.

Task 306, sensing the emitter device 214, shall none-the-less include the sensing of other emitter devices 214 or clouds, and identifying or plotting 308 of the X and Y coordinate position of one or more unique emitter devices 214 or clouds. The task of saving 310 is the storing of each coordinate position, by emitter device 214 or cloud, into a data array variable within the system (perhaps a software or hardware or similar system) that resides within the control system 234. It includes other saving functions, where other system 300 related data is saved, and indeed where other system 200 data needs to be saved. This task is performed, as are all of the other tasks in 300, multiple times per second (although some tasks may be bypassed or become optional by some alternative method 300 or by user configuration or programmed script). Thus each cycle through the process illustrated in 300 results in each task being performed or bypassed, as illustrated in part by the diagram 300.

Thus the tasks of sensing 306, plotting 308, and saving 310, each happen several times per second, and thus record, over time, the position of each emitter device 214, and the position changes over time. Although configuring can happen via the UI system 220, and otherwise, and its data be used in method 300 prior to 312, configuring 312 is the task of retrieving and analyzing data variables from memory by a processor 14 (or via a hardware only process, as by FPGA) residing within the control system 234, which may have originated from the UI system 220. This configuration data that is checked in the configuring task 312, may include mathematical curves, or vectors, programmed scripts for automating system 200 activities, as well as other configuration data specific to the emitter device 214 or cloud, or other components of the tracking system 200.

In a preferred embodiment, the configuration data may be a mathematical curve or vector associated with the kind of tracking object 216 activity anticipated by the user, and configured via an UI system 220, thus enabling the predicting task 314 of the process, particularly if the emitter device 214 is not visible wholly or for a period of time. A user may interact with a UI system 220, independently from the configuration task 312. Once the UI system 220 data is transferred (perhaps via the user interface I/O subsystem 226) to the control subsystem 234, the data may become accessible to the algorithms and methods associated with the configuration task 312, and to future cycles through the process 300. In this manner, and perhaps others, method steps 304, 306, 308, and 310 may all have access to configuration 312 data even though configuring 312 follows these other steps in method 300.

The predicting task 314 includes application of novel and unique algorithms, which may serve purposes of fitting or averaging the plotting data from task 308, with curves identified by users and configured in task 312. This process or similar processes of “averaging” of data types, can also serve to smooth 316 the data passed to the positioning system 318, in such a way that the effect is a more “professional” or less choppy motion (as “seen” or recorded by the mounted video device 242 or another device 242).

Additionally the predicting task 314 may assist in analyzing some or all of the history of past emitter 214 location X, Y data, “learning” from that analysis, and making and storing assumptions as a results, which help to yield positioning data (similar to data of the type found in task 308) related to where the emitter tracking object 216 will likely move next.

Such predictions may also include ranges of data, intermediate sums or products, and statistical standard deviations, and so on. Such predictions of tracking object 216 movements, will be used to aid the responsiveness of the system to such movements, and will include additional, novel and unique methods to insure that predictions are combined with (and rank-ordered as subordinate to or superior to) simple plotting task 308 data, in order to insure both responsiveness and accuracy. The smoothing function 316 assists “responsiveness” by enabling corrections or overcorrections to be integrated back into the positioning 318 function minimizing unacceptable results for users.

Additionally, predicting task 314 processes may derive from or be combined with both configuration data in the form of proprietary algorithms, based on mathematical smoothing functions, in order to affect the commands of the control system 234, and also user-programmable scripts that affect predicting 314, smoothing 316, positioning 318, and other methods of 300 and of the tracking system 200.

The net result of system 300 functioning, is that the tracking device 230 moves in a manner that the mounted device 242 (such as a camera), may record footage that is more aesthetically pleasing, and otherwise more typical of footage shot by a seasoned professional cinematographer or camera operator, rather than footage shot by a machine.

After the smoothing task 316 is completed, the positioning task 318 can be executed, which may include all of the processes executed by the positioning subsystem 236. Thus the motor system is controlled on both a tilt and swivel basis, in order to track a tracking object 216, or otherwise behave in a manner that may be stipulated by the user-programmable script.

Once a positioning task 318 is completed, the process returns to the question of whether or not to continue tracking 302, which is presumed to be Yes, after the initial loop thru process 300, unless, and until, the user presses a button (shared with task 301) or otherwise indicates to the tracking device 230 via UI system 220 or user-definable script, that a pause in the process is desired (which results in the tracking question 302 being answered with No).

If the tracking question is Yes, the tasks of 304 through 318 are executed again, and return to task 302, over and again (in an operating state or a tracking state) until interrupted by a No response to the tracking question 302. If the tracking question 302 is No, a second question 320 is asked, should the system power off? If the answer to that question 320 is also No, then the tracking device 230 is in “paused state” of readiness, unless and until the tracking question 302 is answered by Yes (via a button push or other method), or the power off question 320 is answered by Yes and the power off 322 task is executed. The “pause state” may also, in a preferred embodiment, be the result of holding down the same button 301 for a longer duration than would be the case of powering on or incrementing thru emitter modulation modes. The “power off” 320 question may similarly be answered by the same button 301 being depressed for a longer duration still.

If the power off 322 task is executed then the tracking device 230 is in a state of “being powered off”

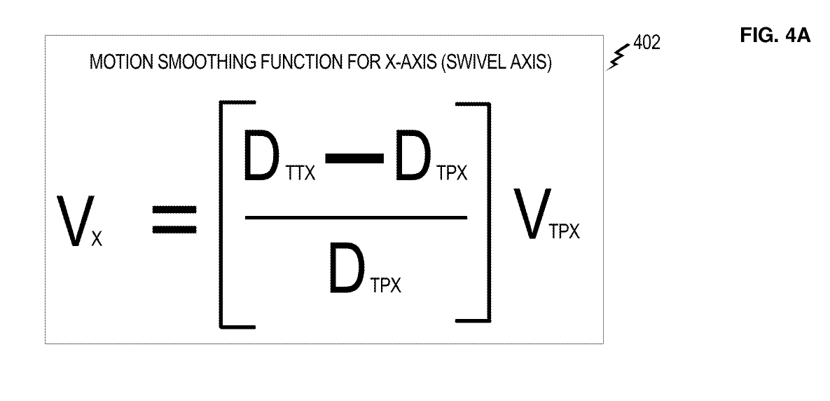

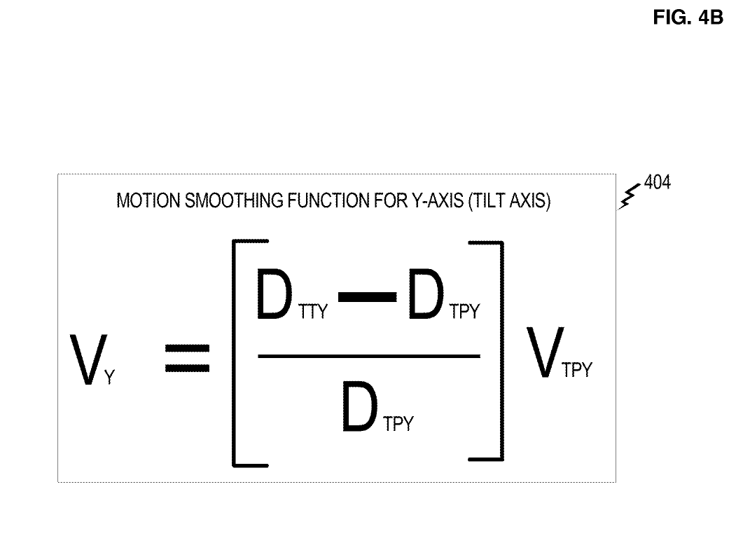

FIG. 4A is an illustration of a sample mathematical function 402 which may be employed by the control system 234 for rotating the swivel axis of the tracking device 230, by the positioning subsystem 236. It enables the velocity relative to the X axis to be a function of the distance that the motors must travel in order to reposition the tracking device 230 to track the tracking object 216.

Vx represents the velocity in the X-axis direction (positive or negative). DTTX represents the total distance to travel along the X-axis. DTPX represents the total distance possible that could be traveled along the X-axis. The difference between DTPX and DTTX, divided by the DTPX represents a fraction of the total distance that must be traveled along the X axis, at any given point in time. And VTPX represents the total velocity along the X axis that is possible by a given motor.

Thus the velocity of x-axis movement is a function of the distance that must be traveled: if that distance is great, the speed is great, if the distance is small, the speed is small. The unique effect of function 402 on the motor speed, is to slow or sooth the motion of the positioning subsystem 236 as it transitions into and out of a stationary state (distance equal to 0) along the X axis.

Other variables and mathematical functions may be combined with this function 402 in order to provide greater programatic manipulation, or configuration via users, or integration with steps shown in process 300, or with user-programmable scripts.

FIG. 4B is an illustration of a mathematical function which may be employed by the control system 234 for rotating the tilt axis of the tracking device 230, by the positioning subsystem 236. It enables the velocity relative to the Y axis to be a function of the distance that the motors must travel in order to reposition the tracking device 230 to track the tracking object 216.

The function can be employed with only slight modification to provide the same benefits along the y-axis, as function 402 provided for the x-axis calculations. Therefore, Vy represents the velocity in the Y-axis direction (positive or negative). DTTY represents the total distance to travel along the Y-axis. DTPY represents the total distance possible that could be traveled along the Y-axis. The difference between DTTY and DTPY, divided by the DTPY represents a fraction of the total distance that must be traveled along the Y axis, at any given point in time. And VTPY represents the total velocity along the Y axis that is possible by a given motor.

The unique effect of function 404 on the motor speed, is to slow or smooth the motion of the positioning subsystem 236 as it transitions into and out of a stationary state (distance equal to 0) along the Y axis.

Mathematical functions shown in both 402 and 404, as well as other functions, may be employed by the control system 234 and positioning subsystem 236 to smooth the motion of the tracking device 230, as if follows the tracking object 216, in order to produce a smooth, pleasing effect by means of the mounted device 242.

Other variables and mathematical functions may be combined with this function 402 in order to provide greater programatic manipulation, or configuration via users, or integration with steps shown in process 300, or with user-programmable scripts.

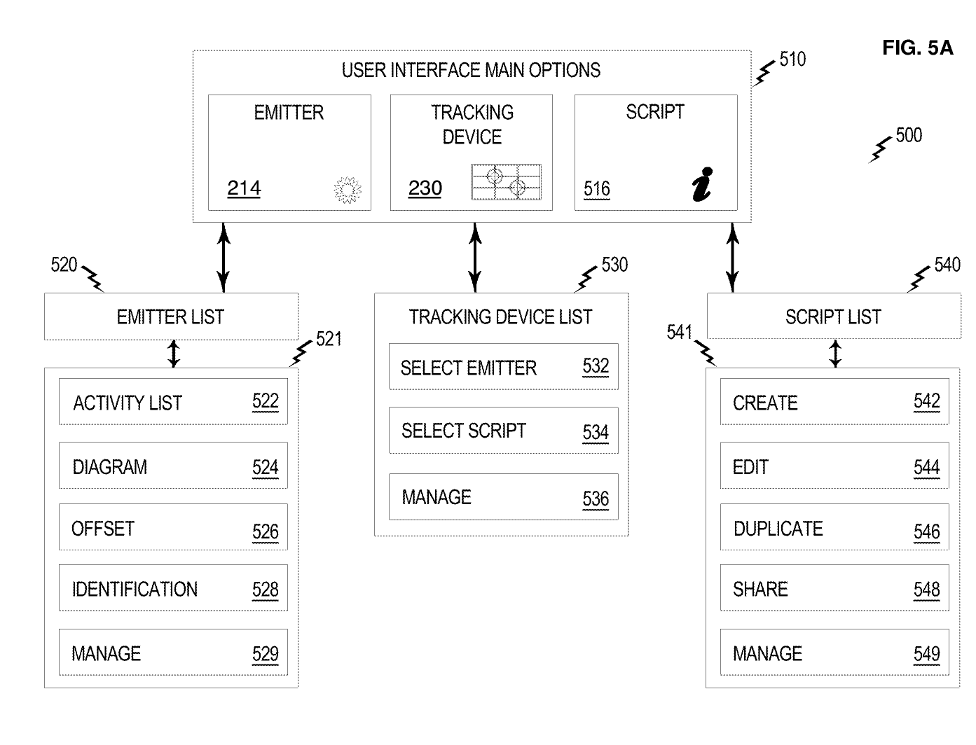

FIG. 5A is a block diagram of a system 500 for implementing the present invention, and more generally for implementing the software application (app) 224, which may be used by the user interface device 222 to configure and control the tracking device 230, emitter system 210, and mounted device 242 via the user interface I/O subsystem 226. System 500 may also be used to integrate multiple tracking devices 230, or clouds of tracking devices, or additional tracking systems 200.

Each object in the diagram 500 may be thought of as tasks, apps, app UI screens, functions or methods, subsystems, etc. In a common model-view-controller programming model, system 500 may be considered to include each of these component pieces, although other subcomponents of system 200 may assist with one or more of them. System 500 may also be embodied within a device, such as a computer system 10, or some subset thereof, even though it might be embodied primarily in memory of such a device, or in an FPGA.

This system 500 includes three general options, emitter 214, tracking device 230, and script 516. By selecting one of these three general options, related sub-options can be selected. If emitter 214 option is selected, an emitter list 520 may appear to view. This may include a list of all emitter devices or clouds 214 of interest.

By selecting an emitter device or cloud 214 from the emitter list 520, at least five new options 521 become available: activity list 522, diagram 524, offset 526, identification 528, and manage 529. By selecting the activity list 522 after selecting an emitter device 214 or cloud from the emitter list 520, a user may be able to specify, from an existing list, an activity representative of the type that the tracking object 216 and its associated emitter device 214 or cloud may be doing (such as jumping on a trampoline, or riding a bike down a street). The activity list function 522 may also enable a user to add, edit or delete activities from the activity list 522.

The diagram function 524, may enable users to graphically plot, in two or three dimensions, the general motion path of a tracking object 216 within an existing or new activity (as listed in the activity list 522). The diagram function 524 may also enable a user to specify expected distances and velocities of the tracking object 216, as well as curves and vectors that may be more detailed than the general motion path anticipated by the tracking object 216, as well as other configuration data. The purpose of these inputs include the novel and unique functionality of being able to more accurately predict tracking object 216 motion, and more accurately respond via the control subsystem 234 and the positioning subsystem 236, by partly providing data to be used by the predicting task 314.

The offset 526 function may enable users to define X- and Y-coordinate units of offset from center, that the user wishes the tracking device 230 to bias its tracking activity. Such bias may provide novel and unique benefits to users by allowing them to frame the tracking object 216 in ways that are not simply centering in nature. The offset task 526 may also enable a user to specify other useful biasing configurations. The identification task 528 may enable users to specify, by emitter device 214 a unique modulation, pulse, or signal that the user wishes to be emitted by the emitter device 214, or which he/she wishes that the sensory subsystem 232 can identify and sense and track, or other activities.

The manage task 529 may enable users to import, export, share, edit, delete, duplicate, etc. configurations items 521, or subordinate tasks associated with 522, 524, 526, and 528, and system 500 specifically, or tracking system 200 generally, as well as with other tracking systems 200. A preferred embodiment enables the unique and novel feature of sharing these configuration settings 521, with others who may be using a tracking device 230, or emitter 214, or mounted device 242, or this or another tracking system 200. It may be possible that options 521 specified for an emitter device 214 or cloud from a list of emitters 520, may also be applied easily to other emitter list 520 devices 214 or clouds.

While user interface options 510 is comprised of emitter 214 data, tracking device 230 data, and script 516 data, these data are representations of the actual emitters 214, tracking devices 230, and scripts 516—and in a preferred embodiment may be icons or user interface buttons or tabs or similar UI control. In one embodiment, when a user first sees the user interface main options 510 screen, there may be three options (214, 230, 516) as tabs (or a similar UI controls) for selecting one of these three options, but the tracking device list 530 may already be selected by default. If the tracking device option 530 is defaulted or selected by default, or if it selected, a list of one or more tracking devices 230 may be displayed. Similarly when emitter list 520 is selected (by default or otherwise), the user interface main options screen 510 may show the emitter list 520, although the other main options emitter 214, tracking device 230, and script 516 may all be accessible with a single click of a button or icon.

When the tracking device 230 option is selected from the main options 510, a list of tracking devices 530 may open (and may default to the currently selected device 530), allowing an easy association of associated emitters 532, and scripts 534. A user may select another tracking devices via the tracking list 530 or via the manage 536 option, or in some other useful way. Various options may be user configurable. Other tracking devices 230 and emitters 214 and scripts 516 from other tracking systems 200 may be selectable from this portion 530 of the system 500.

The select emitter 532 function enables the user to specify which emitter device 214 to associate with the currently-selected tracking device, and hence to track via method 300 or a similar method. The select emitter 532 function may include a list of emitter devices 214 from which to select one. These emitters may come from the tracking system 200 or another tracking system 200 or systems 200. Uniquely, the software app system 500 in this way provides a novel method by which a user can easily reconfigure 312 a tracking device 230, while it is in a “tracking state,” identified by steps in process 300 individually or collectively, to change its focus to a different emitter device 214, or person or tracking object 216. The select emitter 532 option may optionally enable users to select a tracking object 216, as it may be desirable to track a person or tracking object 216 based upon colors or shapes associated with the tracking object 216, with or without an associated emitter 214 attached.

Regardless, the select emitter 532 function may be useful during an event shoot, for example, when switching between members of a band (each band member with an attached tracking device 230 using unique pulsing modulation modes) as they are performing and being filmed, or for switching between members of an athletic team (each as a unique tracking device 230) as they are competing in a sport and being filmed. By configuring the tracking device via 532, to follow a unique modulation, or signal, or pulse (representing one being used by an emitter 214) the associated tracking object 216 can be uniquely identifiable by the sensory subsystem 232, and tracked via the positioning subsystem 236.

When the select script 534 option is selected, the user may be able to select a user-programmable script 516 from a previously-created list 540. Such scripts may enable a user to configure the behavior of a tracking device 230, from the tracking device list 530, to behave in a pre-defined way.

For example, when a script is selected 534, the device may be automated in the following kinds a ways: (1) the device does not enter a “tracking state” until a predetermined amount of time has lapsed, or until am emitter 214 with a particular modulation pulse is “seen” by the sensory subsystem 232; (2) the devices tilts or swivels to an initial direction in which the tracking device 230 should be pointed; (3) the tracking device 230 moves to an ending tilt-and-swivel direction after tracking the emitter 232 for a period of time; (4) the tracking device 230 transitions from one emitter device 214 to another, if the sensory subsystem 232 were to see a second emitter device 214 of yet another unique modulation mode; (5) if the tracking device 230 “loses sight of” the emitter device 214 it may continue on a path informed by a particular configuration curve or activity curve (say, similar to the motion of a tracking object 216 if on a trampoline); (6) movement (tilt, swivel, otherwise) into or out of a shot, according to user-defined parameters, such as panning or tilting that is not following an emitter temporarily; (7) etc. These automation scripts are generally intended to automate a variety of activities based on certain conditions being met, as explained more later.

The manage feature 536 of app system 500 may enable the adding, deleting, importing, exporting, duplicating, etc. of items and features components of the tracking device list 530 portion of the software app system 500, including from other tracking systems 200. As with emitters and list 520, or scripts and list 540, it may be possible that options found in 530 may be easily applied to more than one tracking device 230 at a time.

The script list option 516, if selected, may open a script list 540. Scripts, selected from a script list 540, can then be created 542, edited 544, duplicated 546, shared 548 (imported & exported), and otherwise managed 549. These scripts may be created 542, customized 544, and selected 534 for implementation, and may result in virtually limitless customized activities that can be automated or partly automated relative to the tracking device 230 or emitter 214.

The create 542 feature may be used to create the script using screens and features designed for that purpose. The edit 544 feature may be used to edit a script using screens and features designed for that purpose. The duplicate 546 feature may be used to duplicate a script using screens and features designed for that purpose, and then further edited 544 so as to quickly create a variation from an already existing script. The share 548 feature may be used to import or export scripts using screens and features designed for that purpose, and shared within this system 200 or another system 200 with other users. Scripts thus shared may be moved in one way or other, via computer systems 10, user interface I/O subsystems 226, or via other means.

A preferred embodiment of the system may include a computer system 10 which includes a website server where scripts can be exchanged (with or without money) between other tracking device 230 users. Companies, including a tracking device 230 manufacturer, may create one or more scripts customized to specific activities (ice skating, jumping on a trampoline, etc.) in order to provide users with enhanced options. These scripts are integrated into the tracking process via step 312 of method 300, and perhaps elsewhere.

Thus benefits like the following may accrue to a users of multiple tracking devices 230: standardizing the “looks” of “shots.” Tracking device 230 users may be able to develop areas of script automation expertise, and sell their specialized scripts to others for mutual advantage. As with manage features 529 and 536 for emitters and tracking devices, management 549 of the script list may enable expanded functionality via users, tracking device 230 manufacturers, or third parties who develop software “add-ins” to the system 500, to include activities useful to users, that are not already covered in the other options within the script list 540 software app system 500.

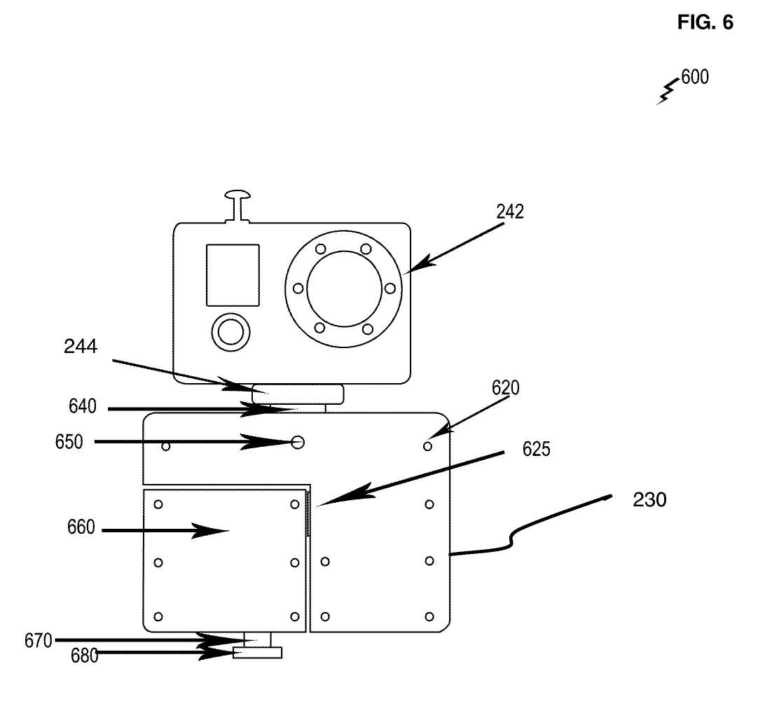

FIG. 6 is a stylized illustration of a tracking system device diagram 600 for implementing one embodiment of the present invention, and includes a mounted device 242; a tracking device 230 (including elements 620, 625, 640, 650, 660, 670, and 680), an attachment adapter 244 associated with the mounting system 240, and 640 which is associated with the tracking system 230 and which combines with 244 to enable “quick coupling” of the mounted device and the tracking device.

While system 600 shows a mounted camera as the mounted device 242, it might also show a mounted light, or microphone, or some other mounted device 242. The mounted adapter 244 is specific to the mounted camera device 242, and thus may be different for a camera, a light, or a microphone—although any adapter device 244 may work with 640 to enable quick coupling and quick decoupling. The other half of the mounted adapter, 640, is a “universal adapter” that is “permanently” attached to the tracking device 230.

Element 620, is joined to the left side 660 via a bearing-and-axil subsystem 625. Element 620 represents the right half of the tracking device 230 and houses the sensory subsystem 232, the control subsystem 234, and half of the positioning subsystem 236. Specifically, element 620, contains the motor assembly (or servo assembly) and bearing-and-axil subsystem 625 required to tilt the device about the Y-axis or vertical-axis. Thus 620 can tilt, and when it does, the sensory subsystem 232, control subsystem 234, part of the positioning subsystem 236, as well as mounted adapters 244 and 640, and the mounted device 242 will also tilt in synchronous motion.

A covered hole 650, is found in 620, and provides a window through which the sensory subsystem 232 can “see” or sense the emitter device 214 or cloud that it is supposed to track. The element 660 contains the battery, motor assembly, and axel assembly (670) required to swivel the device about the X-axis or horizontal-axis, and comprises the other half of the positioning subsystem shown as 236. Thus 660 can swivel, and when it does, the associated other half, 620, also swivels, and the mounted adapters 244 and 640, and the mounted device 242 will also swivel in lock-step. The element 680 is a universal adapter (and like all elements of 600, may also have parts not shown), enabling the mounting of the tracking device 230, and more specifically the swivel axel assembly 670 to be mounted to “any” tripod or other suspending device or grip device or mechanism. These “universal adapters” provide further unique and novel benefits to users of the present invention; specifically, allowing users to quickly mount and dismount the tracking device 230 from other devices.

The camera, as shown as the mounted device 242, may measure 2 inches by 3 inches by 2 inches in size. Similarly, the tracking device 230, as illustrated in 600, may measure 3 inches by 3.5 inches by 1.5 inches in size. Thus, system 600 in this embodiment possesses the novel and unique benefits of being compact, battery powered, and portable. As will be shown later, the tracking device 230 is also designed to be easily assembled (and hence less expensive), and to be uniquely rugged.

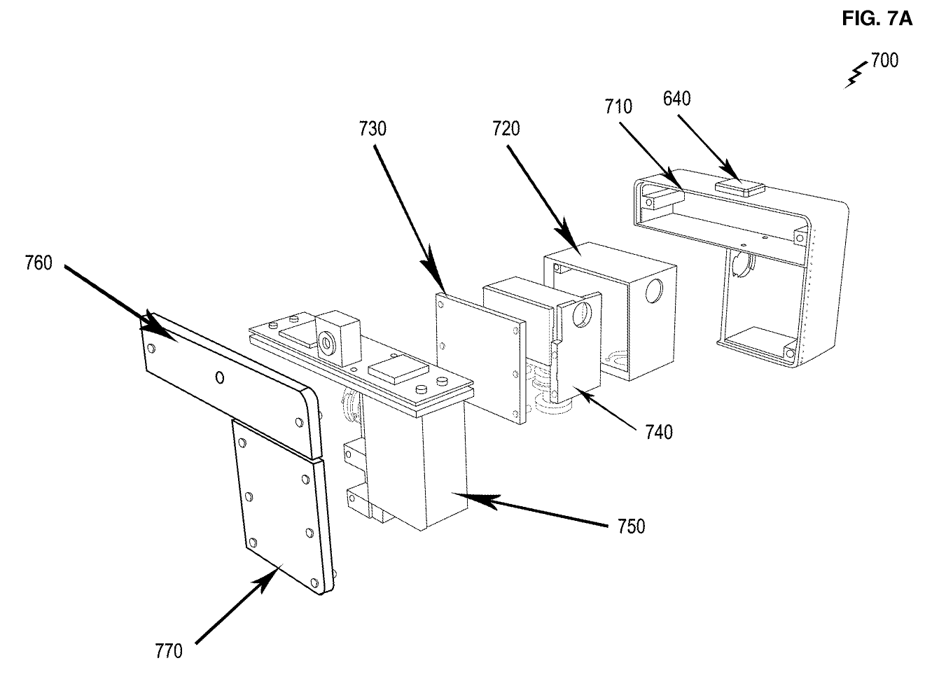

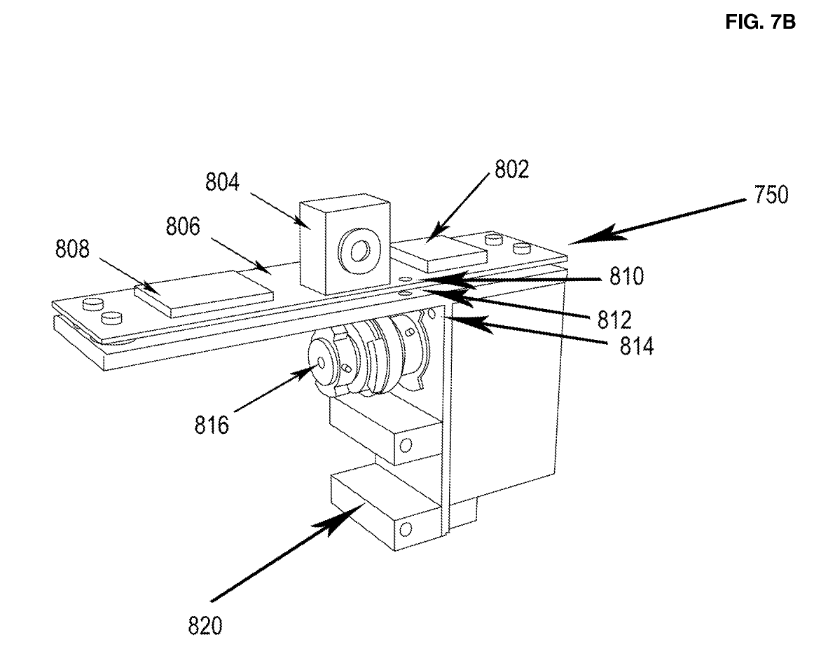

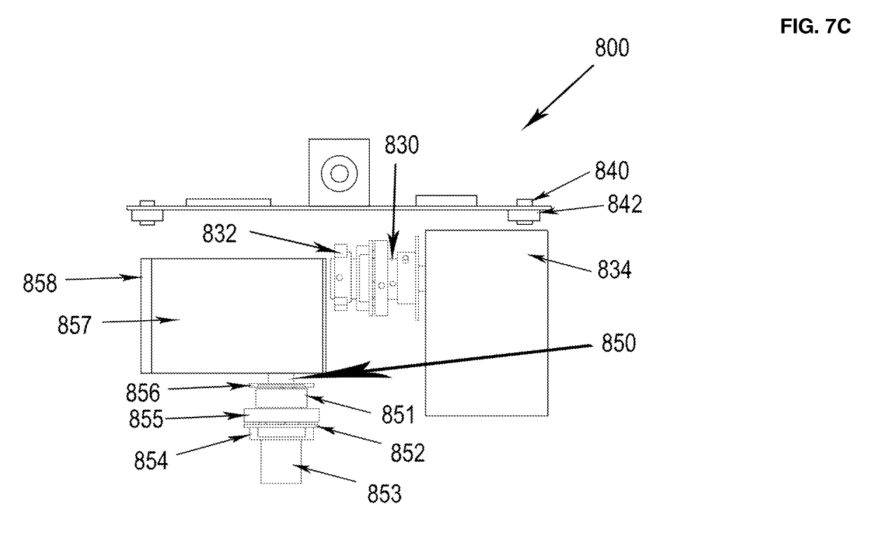

FIG. 7A is an illustration of a stylized tracking system assembly diagram 700 for implementing an embodiment of the present invention, and may include a universal adapter 640; an enclosure 710 (corresponding with 620), and into which subassembly 750 is inserted, and into which doors 760 and 770 are fastened; and enclosure 720, into which subassembly 740 is inserted, and door 730 is fastened.

In one embodiment, element 710 is perhaps milled of a solid aluminum block, so that it is uniquely strong, and so that it fits with the subassemblies precisely, without wiggling when the tracking device 230, and the enclosure 710 moves. The enclosure 710 is also notched in order to be fitted with doors 760 and 770 in ways that may be uniquely dust-proof, pressure-resistant, and water-resistant or water-proof, once a rubber o-ring (not shown) is fitted into 710 where the doors are then fitted.

The subassembly 750, in one embodiment, may also include a solid all-aluminum mount system (or similar system), onto which the servo motors, batteries, circuit board, and axel systems may be partially sub-assembled. The size of the subassembly is engineered to precisely fit within the enclosure 710, with the doors 760, 770 attached. These novel features uniquely enable easy assembly, which may translate into lower costs of assembly labor costs, lower product price, and higher quality of the assembled product.

Other components of subassembly 750 will be detailed later. Subassembly 740 includes a servo mother (or other motor), a battery, and an axel assembly. It fits precisely within enclosure 720 (associated with 660), and thus provides similarly unique benefits provided by subassembly 750. Other components of subassembly 740 will be detailed later. Some screws or similar devices, are shown attached to doors 730, 760 and 770. And while many of these attachment screws or devices are functional, some may be simply aesthetic, in order to provide a design that is appealing to customers.

Enclosures like 710 and 720 serve, among other functions, to seal the tracking device 230, from outside elements like dust and water, and they may be filled with special “marine gels” that are non-electrically conductive, but that none-the-less provide pressure against water seeping into the enclosure. Thus providing for further protection against waterproofing and dust-proofing and generally guarding against the entry of elements from outside of the enclosure.

The shape, of enclosures 710 and 720, as well as the sub-assemblies and doors of system 700, are designed to be aesthetically attractive, while also being efficient shapes for CNC milling processes, thus again strengthening the novel and unique aspect of strength that derives from parts that may be milled from solid aluminum (or similarly produced in a manner that preserves unique strength). When sensory subsystem 232 requires RF transmission or receiving, or other sensory activity, these devices shown in 600 and 700 and elsewhere may be CNC'd or otherwise produced in order to be more amenable to the tracking signals or emissions sensed by the sensory subsystem 232 and emitted by emitter device 214.

Subassembly 750 shows assemblies and subassemblies that combine to enable easy assembly and rugged construction. This method of design and assembly also enables the additional use of ball bearings, “o-rings,” and “boots” and “gels” to protect the device from elements, including dust and water. System 750 includes illustrated axels and ball bearings although not prominently shown until later; these ball bearing devices may also be dust and water proof, and thus combine, with other precautions not detailed here, to enable the securing of the overall tracking device 230 from water or dust at its most vulnerable (rotation) points.

FIG. 7B further serves to illustrate how an embodiment of the present invention, is designed to provide novel and unique benefits of low labor assembly costs, and rugged strength. Subassembly 750 may be used for implementing an embodiment of the present invention, as well as an illustration all non-aluminum-mounting components (or all non-aluminum-alternative mounting components) that may be included within enclosures 710 and 720.

The subassembly 750 in FIG. 7B may include a circuit board 806, shown with some of its components and features; an axel assembly 816 shown along with some of its features; and an “aluminum”-mounting component 820 to which the assemblies or components are mounted. Note that a battery and covered servo mother are also illustrated in 750, but are not numbered for discussion until later.

Circuit board 806 may include some or all elements of computer 12, and in a preferred embodiment may include a processor chip 14, shown here as 802, and include the control subsystem 232 with associated memory and software, etc.; a sensory subsystem 232, shown here as 804, and may include other devices for sensing some non-IR emitter device 214 or cloud; a wi-fi (or similar technology) network chip 42, shown here as 808 (also part of the control subsystem 234, a part that may be called a tracking device I/O subsystem); and similar devices common to computers 10, or circuit boards 806, or sensors like those previously discussed in relation to the present invention, but not illustrated in 750, but necessary to implement an embodiment of the present invention and tracking system 200.

The circuit board 806 has a hole 810 used to feed one or more electrical wires, for power and control and possibly other uses (such as wi-fi antenna connections), connecting the circuit board 806 with the servo motors and batteries (not numbered until diagram 800). Notice that the axel assembly also has a hole 816 for housing wires that connect between electrical devices contained within subassembly 750 and 740. The aluminum-mounting component 820 also has two holes 812, and 814 for wires, to accommodate the same electrical connections of components described before. Such accommodations enable the present invention to be both rugged and functional, as will be discussed in greater detail using illustration 800.

FIG. 7C is another illustration of components 800 of the device shown in 700. The non-aluminum-mounting components (or the non-aluminum-alternative components that are CNC'd to hold the other components) shown in 800 illustrate the unique and novel nature of the design of an embodiment of the present invention, to provide both a quick assembly process, as well as a rugged strength of operation and handling once assembled. Specifically, screws or other attachment devices 840 mount the circuit board 806 to the aluminum-mounting component 820, by providing an o-ring 840 which absorbs shock sustained from the aluminum enclosure (were it to be dropped, or were enclosures 710 and 720 associated with the tracking device 230 to be dropped or otherwise jolted) the enclosing, thus protecting the delicate chips (802, 808) and other components (including camera 804) mounted to the circuit board 806.

Additionally 700 and 800 show bearing and axil systems designed so as to be press-fitted and enable a water-resistance or waterproofing connection to components of the tracking device 230 which are outside of the aluminum (or aluminum-alternative) enclosure system. This provides for ruggedness as well as waterproofing.

Servos 858 and another obscured from view directly behind battery 834, are likewise buffered from direct forces to their protruding axils (illustrated by 850 for one servo, and shown but not numbered for the other servo) by use of components such as 856, and 851 that distribute shock from the axils to the enclosure rather than the servo gear systems and motor. Servos 858 and another obscured from view directly behind battery 834, are, when attached to their respective aluminum mounting components, like 820, and then assembled into their enclosures, like 720 and 710, are held in place firmly and thus forces of bumping into other objects (including aluminum mounting components like 820 and aluminum enclosures 720 and 710) is minimized.

Various components are used in a unique combination to make the device more shock-resistant and rugged, including the following: Force on the axils protruding from the servos (like 858) are redistributed to the aluminum mounting components, like 820, and their enclosures, 720 and 710, by means of the other components illustrated in 800.

Components 856 and 851 (not numbered for the second servo), rests against an aluminum mounting component like 820, on the top, nearest the servo, and are attached to servo axel 850, and thus redistribute upward forces on 850 to its aluminum mounting component and from there through to the enclosures 710 and 720 associated with the tracking device 230.

Similarly, components 855, 852, 854 rest upon the aluminum mounting component like 820 on the bottom, and thus distribute downward forces to the aluminum mounting component and from there through to the enclosures 710 and 720, associated with the tracking device 230. Components may include ball bearing devices such as 854 and 855 so that while being held securely, they can still rotate (tilt or swivel) as required. These ball bearing devices and other components such as 856, may be partly embedded within the aluminum mounting components like 820, and anchored there through screws or other anchoring devices and mechanisms, to add additional strength and immobility to parts that should not move.

These ball bearing devices themselves may themselves be dust-proof and waterproof, and thus combine, with all other precautions, to enable the securing of the overall tracking device 230 from water or dust at its most vulnerable (rotation) points.

The greater, encompassing axel 853 protrudes through the enclosure 740, and anchors to the universal adapter 680, which in turn mounts to “any” tripod or other mounting/suspension device.

Component 830 is unique in that it spans across subcomponent 710 and 740, attaching them together firmly, and providing a means of tilting or rotating in the Y-axis. As can be seen on 830, this and other components thus attached to servo axils and to aluminum mounting component like 820, are also anchored together via screws or other anchoring devices and mechanisms, to add additional strength and immobility to parts that should not move or separate. They may not only be secured by bevels or notches machined out of he aluminum mounting components like 820, but additionally they may be secured to each other via such beveling mechanisms.

As was illustrated in 816, 830 has holes in its center, and side, in order to feed one or more wires used for power, control and perhaps other purposes such as wi-fi antenna connections, between components 740 and 750, enabling communication and control and power to move between sides in a protected manner from outside elements. Finally, component 832 is a ball bearing device that is embedded and anchored (as previously described briefly herein previously) within the aluminum (or aluminum-alternative material) enclosure 720, which houses the subassembly 740, and which thus provides a rigid connection between the two assemblies, as well as a smooth rotation (Y-axis, tilt direction), and water/dust proofing safeguards to the subassembly 720, and thus to the tracking device 230 generally.

The components in 700 additionally combine to hold the servos securely such that even if they are not mounted at centers of gravity and rotation, they will nonetheless distribute resulting forces to the enclosures 740 and 750, and by thus minimize some of the needs to for centering rotational movements, and gain rather the benefits of minimizing the volume of the overall tracking device 230. And because they enable the tracking device 230 swivel and tilting ability, they distribute the forces and momentums of such actions to the rigid enclosure itself, reducing the need for larger, “centered” devices, along with their associated subassemblies. And while the present invention may be scaled for various larger loads of various larger mounted devices 242, the device's relative nature of being compact, portable, rugged is preserved by this compact, if off-centered, device design. Thus, in summary, components shown in 750 and 800 synergistically enhance stability and ruggedness of the tracking device 230, while minimizing its size, and thus add their associated novel and unique benefits to users.

Within this application, the tracking device 230 is sometimes referred to simply as “tracker.” An emitter device 214 is sometimes referred to as simply as “emitter.” The user interface device 222 is sometimes referred to as simply the “user interface.” The sensory subsystem 232 is sometimes referred to as “detector.” The control subsystem 234 is sometimes referred to as “controller.” And the positioning subsystem 234 is sometimes referred to as “positioner.” The device I/O subsystem 246 is sometimes called the “mount I/O system.” The mounting system 240 is sometimes called a “mount system.” The attachment adapter 244 is sometimes called an “adapter.”

We claim:

1. A system for tracking a cinematography target, the system using multiple components to identify and track the target, the system comprising:
an emitter configured to attach to a target and to emit a tracking signal that is directionally identifiable by a tracker, the emitter comprising:
an output module configured to emit the tracking signal, wherein:
the tracking signal comprises a non-continuous electromagnetic signal according to a specified pattern, and
the specified pattern is selectable from a collection of distinct patterns.

2. The system of claim 1, wherein the tracker recognizes and tracks the electromagnetic signals which are pulsed according to the specified pattern.

3. The system of claim 1, further comprising a plurality of emitters, wherein each of the emitters within the plurality of emitters pulses the same specified pattern.

4. The system of claim 3, wherein the plurality of emitters can be synced with each other such that all such emitters pulse the same pattern at the same frequency and timing.

5. The system of claim 3, wherein the tracker determines an average location of the plurality of emitters and tracks the plurality of emitters as a single point in space.

6. The system of claim 1, wherein the emitter receives commands from a tracker and returns information to the tracker.

7. The system of claim 1, wherein the tracker comprises an antenna array that is configured to detect a relative direction of an emitter by at least determining a phase shift between two or more antennas within the antenna array.

8. The system of claim 1, wherein the tracker comprises an adjustable band pass filter that is configurable to allow through a frequency of the specified pattern, further wherein the collection of distinct patterns can comprise multiple distinct frequencies.

9. The system of claim 8, wherein the adjustable band pass filter is configured to allow through a particular color of reflected light, such that the tracker tracks an object that is reflecting the particular color.

10. The system of claim 1, wherein the tracker comprises an LED receptor system which is used by the tracker to receive encoded instructions from the emitter.

11. The system of claim 1, wherein the tracker comprises an LED receptor system which is used by the tracker to receive encoded instructions from another tracker.

12. The system of claim 1, wherein the tracker comprises motors that are configured to rotate at least a portion of the tracking device in concert with the movement of the emitter.

13. The system of claim 12, wherein the motors are configurable to track along a user provided pathway when tracking the emitter.

14. A computer-implemented method for tracking a cinematography target, the system using multiple components to identify and track the target, the method comprising:
displaying to a user, at an emitter, an individually selectable set of pulsing patterns;
receiving from the user an indication selecting one of the pulsing patterns from the set of pulsing patterns;
initiating, at the emitter, the pulsing pattern, wherein the pulsing pattern is uniquely detectable by a tracker; and
communicating to the tracker various sensor data, wherein the sensor data is distinct from the pulsing pattern.

15. The method as recited in claim 14, wherein the sensor data comprises information relating to the motion of the emitter.

16. The method as recited in claim 15, wherein the sensor data is generated by one or more devices selected from the group consisting of an accelerometer, a gyroscope, an altimeter, and digital compass, and a GPS unit.

17. The method as recited in claim 15, wherein the tracker determines a predicted location of the emitter based upon the sensor data.

18. The method as recited in claim 15, further comprising:
generating, at the tracker, a virtual two dimensional grid, wherein the virtual two dimensional grid represents physical space around the tracker; and
determining a positioning of the emitter within the virtual two dimensional grid.

19. The method as recited in claim 18, further comprising:
determining a positioning of another tracker within the virtual two dimensional grid.

20. The method as recited in claim 14, further comprising:
receiving, from a user at the tracker, an indication of a predicted emitter motion; and
actuating one or more motors within the tracker in accordance with the motion, while tracking the emitter.
